(19) United States
(12) Patent Application Publication
(10) Pub. No.: US 2013/0182768 A1
(43) Pub. Date: Jul. 18, 2013

(54) METHOD AND APPARATUS FOR ENCODING / DECODING VIDEO USING ERROR COMPENSATION

(71) Applicants: Se Yoon Jeong, Daejeon (KR); Jin Ho Lee, Daejeon (KR); Hui Yong Kim, Daejeon (KR); Sung Chang Lim, Daejeon (KR); Ha Hyun Lee, Seoul (KR); Jong Ho Kim, Daejeon (KR); Suk Hee Cho, Daejeon (KR); Jin Soo Choi, Daejeon (KR); Jin Woong Kim, Daejeon (KR); Chie Teuk Ahn, Daejeon (KR); Hyun Wook Park, Daejeon (KR)

(72) Inventors: Se Yoon Jeong, Daejeon (KR); Jin Ho Lee, Daejeon (KR); Hui Yong Kim, Daejeon (KR); Sung Chang Lim, Daejeon (KR); Ha Hyun Lee, Seoul (KR); Jong Ho Kim, Daejeon (KR); Suk Hee Cho, Daejeon (KR); Jin Soo Choi, Daejeon (KR); Jin Woong Kim, Daejeon (KR); Chie Teuk Ahn, Daejeon (KR); Hyun Wook Park, Daejeon (KR)

(73) Assignee: KOREA ADVANCED INSTITUTE OF SCIENCE AND TECHNOLOGY, Daejeon (KR)

(21) Appl. No.: 13/877,055

(22) PCT Filed: Sep. 30, 2011
(86) PCT No.: PCT/KR2011/007263

§ 371 Date: Mar. 29, 2013

(30) Foreign Application Priority Data
Sep. 30, 2010 (KR) 10-2010-0094955
Sep. 30, 2011 (KR) 10-2011-0099680

(51) Int. Cl. H04N 7/26

(52) U.S. Cl. CPC H04N 19/00733
USPC 375/240.14

(57) ABSTRACT

According to the present invention, a method for decoding a video in a skip mode comprises the steps of: deriving a pixel value of an estimation block for a current block; deriving an error compensation value for the current block; and deriving a pixel value of a final prediction block using the pixel value of the prediction block and the error compensation value. According to the present invention, the amount of transmitted information is minimized, and the efficiency of video encoding/decoding is improved.

### TECHNICAL FIELD

The present invention relates to video processing, and more particularly, to video coding/decoding method and apparatus.

### BACKGROUND ART

Recently, with the expansion of broadcasting services having high definition (HD) resolution in the country and around the world, many users have been accustomed to a high resolution and definition video, such that many organizations have conducted many attempts to develop next-generation video devices. In addition, the interest in HDTV and ultra high definition (UHD) having a resolution four times higher than that of HDTV have increased and thus, a compression technology for higher-resolution and higher-definition video have been required.

An example of the video compression technology may include an inter prediction technology predicting pixel values included in a current picture from a picture before and/or after the current picture, an intra prediction technology predicting pixel values included in a current picture using pixel information in the current picture, a weighted prediction technology for preventing deterioration in image quality due to illumination change, or the like, an entropy coding technology allocating a short code to symbols having a high appearance frequency and a long code to symbols having a low appearance frequency, or the like. In particular, when prediction for the current block is performed in a skip mode, a prediction block is generated by using only a value predicted from a previous coded region and separate motion information or residual signals are not transmitted from a coder to a decoder. Video data may be efficiently compressed by the video compression technologies.

### DISCLOSURE

### Technical Problem

The present invention provides video coding method and apparatus capable of improving video coding/decoding efficiency while minimizing transmitted information amount.

The present invention also provides video decoding method and apparatus capable of improving video coding/decoding efficiency while minimizing transmitted information amount.

The present invention also provides skip mode prediction method and apparatus capable of improving video coding/decoding efficiency while minimizing transmitted information amount.

### Technical Solution

In an aspect, there is provided a video decoding method, including: deriving a pixel value of a prediction block for a current block; deriving an error compensation value for the current block; and deriving a pixel value of a final prediction block by using the pixel value and the error compensation value of the prediction block, wherein the error compensation value is a sample value of the error compensation block for compensating an error between the current block and the reference block and the reference block, which is a block in a reference picture, is a block including prediction value (predictor) related information of the pixel in the current block and the prediction for the current block is performed in an inter-picture skip mode.

The deriving of the pixel value of the prediction block for the current block may include: deriving motion information on the current block by using a previously decoded block; and deriving the pixel value of the prediction block by using the derived motion information.

The previously decoded block may include neighboring blocks of the current block.

The previously decoded block may include the neighboring blocks of the current block and neighboring blocks of a collocated block in the reference picture.

At the deriving of the pixel value of the prediction block by using the derived motion information, the pixel value of the derived prediction block may be a pixel value of the reference block indicated by the derived motion information.

When the reference block is two or more, at the deriving of the pixel value of the prediction block by using the derived motion information, the pixel value of the prediction block may be derived by a weighted sum of the pixel values of the reference block and the reference block may be a block indicated by the derived motion information.

The deriving of the error compensation value for the current block may include: deriving the error parameter for an error model of the current block; and deriving an error compensation value for the current block by using the error model and the derived error parameter.

The error model may be a 0-order error model or a 1-error error model.

At the deriving of the error parameter for the error model of the current block, the error parameter may be derived by using the information included in the neighboring blocks of the current block and the block in the reference picture.

When the reference block is two or more, at the deriving of the error compensation value for the current block by using the error model and the derived error parameter, the error compensation value may be derived by a weighted sum of the error block values and the error block value may be the derived error compensation value of the current block for each of the reference blocks.

At the deriving of the pixel value of the final prediction block by using the pixel value of the prediction block and the error compensation value, the error compensation value may be selectively used according to information indicating whether error compensation is applied and the information indicating whether the error compensation may be applied is transmitted from a coder to a decoder by being included in a slice header, a picture parameter set, or a sequence parameter set.

In another aspect, there is provided a prediction method of an inter-picture skip mode, including: deriving a pixel value of a prediction block for a current block; deriving an error compensation value for the current block; and deriving a pixel value of a final prediction block by using the pixel value and the error compensation value of the prediction block, wherein the error compensation value is a sample value of the error compensation block for compensating an error between the current block and the reference block and the reference block, which is a block in a reference picture, is a block including prediction value related information of the pixel in the current block.

The deriving of the pixel value of the prediction block for the current block may include: deriving motion information on the current block by using a previously decoded block; and deriving the pixel value of the prediction block by using the derived motion information.

The deriving of the error compensation value for the current block may include: deriving the error parameter for an error model of the current block; and deriving an error compensation value for the current block by using the error model and the derived error parameter.

In an another aspect, there is provided an video decoding apparatus, including: an entropy decoder performing entropy decoding on bit streams received from the decoder according to probability distribution to generate residual block related information; a predictor deriving a pixel value of a prediction block for a current block and an error compensation value for the current block and deriving a pixel value of a final prediction block by using the pixel value and the error compensation value of the prediction block; and an adder generating a recovery block using the residual block and the final prediction block, wherein the error compensation value is a sample value of the error compensation block for compensating an error between the current block and the reference block and the reference block, which is a block in a reference picture, is a block including prediction value related information of the pixel in the current block, and the predictor performs the prediction for the current block in an inter-picture skip mode.

The predictor may derive motion information on the current block by using a previously decoded block and derive the pixel value of the prediction block by using the derived motion information.

The predictor may derive the error parameter for an error model of the current block and derive an error compensation value for the current block by using the error model and the derived error parameter.

### Advantageous Effects

As set forth above, the video coding method according to the exemplary embodiments of the present invention can improve the video coding/decoding efficiency while minimizing the transmitted information amount.

In addition, the video decoding method according to the exemplary embodiments of the present invention can improve the video coding/decoding efficiency while minimizing the transmitted information amount.

Further, the skip mode prediction method according to the exemplary embodiments of the present invention can improve the video coding/decoding efficiency while minimizing the transmitted information amount.

### DESCRIPTION OF DRAWINGS

FIG. 1 is a block diagram showing a configuration of a video coding apparatus according to an exemplary embodiment of the present invention.

FIG. 2 is a block diagram showing a configuration of a video decoding apparatus according to an exemplary embodiment of the present invention.

FIG. 3 is a flow chart schematically showing a skip mode prediction method using error compensation according to an exemplary embodiment of the present invention.

FIG. 4 is a flow chart schematically showing a method for deriving pixel values of a prediction block according to an exemplary embodiment of the present invention.

FIG. 5 is a conceptual diagram schematically showing an example of neighboring blocks of the current block, which are used at the time of deriving motion information in the exemplary embodiment of FIG. 4.

FIG. 6 is a conceptual diagram schematically showing the peripheral neighboring blocks of the current block and peripheral neighboring blocks of the collocated block in a reference picture, which are used at the time of deriving the motion information in the exemplary embodiment of FIG. 4.

FIG. 7 is a flow chart schematically showing a method for deriving an error compensation value according to an exemplary embodiment of the present invention.

FIG. 8 is a conceptual diagram schematically showing an embodiment of a method for deriving error parameters for a 0-order error model according to an exemplary embodiment of the present invention.

FIG. 9 is a conceptual diagram schematically showing another embodiment of a method for deriving error parameters for a 0-order error model according to an exemplary embodiment of the present invention.

FIG. 10 is a conceptual diagram schematically showing another embodiment of a method for deriving error parameters for a 0-order error model according to an exemplary embodiment of the present invention.

FIG. 11 is a conceptual diagram schematically showing another embodiment of a method for deriving error parameters for a 0-order error model according to an exemplary embodiment of the present invention.

FIG. 12 is a conceptual diagram schematically showing another example of a method for deriving error parameters for a 0-order error model according to the exemplary embodiment of the present invention.

FIG. 13 is a conceptual diagram schematically showing an embodiment of a motion vector used for deriving an error compensation value using a weight in the exemplary embodiment of FIG. 7.

FIG. 14 is a conceptual diagram showing an exemplary embodiment of a method for deriving pixel values of a final prediction block using information on positions of a prediction object pixels in the current block.

### MODE FOR INVENTION

Hereinafter, exemplary embodiments of the present invention will be described in detail with reference to the accompanying drawings. In describing exemplary embodiments of the present invention, well-known functions or constructions will not be described in detail since they may unnecessarily obscure the understanding of the present invention.

It will be understood that when an element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having the other element intervening therebetween. Further, in the present invention, “comprising” a specific configuration will be understood that additional configuration may also be included in the embodiments or the scope of the technical idea of the present invention.

Terms used in the specification, ‘first’, ‘second’, etc. can be used to describe various components, but the components are not to be construed as being limited to the terms. The terms are only used to differentiate one component from other components. For example, the ‘first’ component may be named the ‘second’ component without being departed from the scope of the present invention and the ‘second’ component may also be similarly named the ‘first’ component.

Furthermore, constitutional parts shown in the embodiments of the present invention are independently shown so as to represent characteristic functions different from each other. Thus, it does not mean that each constitutional part is constituted in a constitutional unit of separated hardware or software. In other words, each constitutional part includes each of enumerated constitutional parts for convenience. Thus, at least two constitutional parts of each constitutional part may be combined to form one constitutional part or one constitutional part may be divided into a plurality of constitutional parts to perform each function. The embodiment where each constitutional part is combined and the embodiment where one constitutional part is divided are also included in the scope of the present invention, if not departing from the essence of the present invention.

In addition, some of constituents may not be indispensable constituents performing essential functions of the present invention but be selective constituents improving only performance thereof. The present invention may be implemented by including only the indispensable constitutional parts for implementing the essence of the present invention except the constituents used in improving performance. The structure including only the indispensable constituents except the selective constituents used in improving only performance is also included in the scope of the present invention.

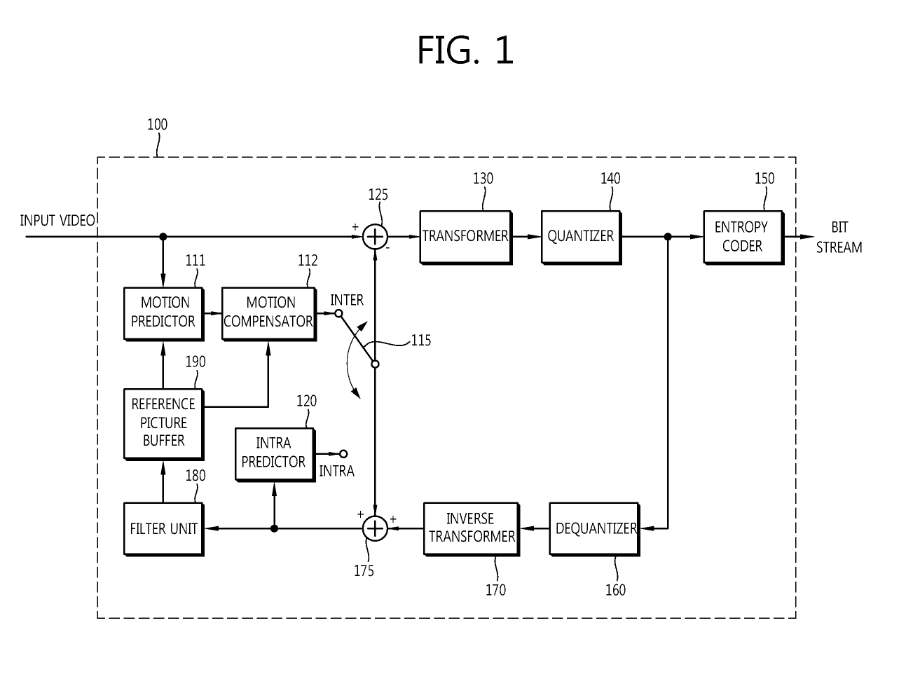

FIG. 1 is a block diagram showing a configuration of a video coding apparatus according to an exemplary embodiment of the present invention. Referring to FIG. 1, a video coding apparatus 100 includes a motion predictor 111, a motion compensator 112, an intra predictor 120, a switch 115, a subtractor 125, a transformer 130, a quantizer 140, an entropy coder 150, a dequantizer 160, an inverse transformer 170, an adder 175, a filter unit 180, and a reference picture buffer 190.

The video may also be referred to a picture. Hereinafter, the picture may have the same meaning as the video according to a context and a need. The video may include both of a frame picture used in a progressive scheme and a field picture used in an interlace scheme. In this case, the field picture may be composed of two fields including a top field and a bottom field.

The block means a basic unit of the video coding and decoding. At the time of the video coding and decoding, the coding or decoding unit means a split unit when performing the coding and decoding by splitting the videos, which may be called a macro block, a coding unit (CU), a prediction unit (PU), PU partition, a transform unit (TU), a transform block, or the like. Hereinafter, the block may have one of the above-mentioned block types according to a unit in which the coding is presently performed.

The coding unit may be hierarchically split based on a quad tree structure. In this case, whether the coding unit is split may be represented by depth information and a split flag. The coding unit having the largest size is referred to as a largest coding unit (LCU) and the coding unit having the smallest size is referred to as a smallest coding unit (SCU). The coding unit may have a size of 8×8, 16×16, 32×32, 64×64, 128×128, or the like. Herein, the split flag indicates whether the present coding unit is split. In addition, when the split depth is n, the split depth may indicate that the split is performed n times in the LCU. For example, split depth 0 may indicate that the split is not performed in the LCU and split depth 1 may indicate that the split is performed once in the LCU. As described above, the structure of the coding unit may also be referred to as a coding tree block (CTB).

For example, the single coding unit in the CTB may be split into a plurality of small coding units based on size information, depth information, split flag information, or the like, of the coding unit. In this case, each of the small coding units may be split into a plurality of smaller coding unit based on the size information, the depth information, the split flag information, or the like.

The video coding apparatus 100 may perform coding on input videos with an intra mode or an inter mode to output bit streams. The intra prediction means intra-picture prediction and the inter prediction means inter-picture prediction. In the case of the intra mode, the switch 115 is switched to intra and in the case of the inter mode, the switch 115 is switched to inter mode. The video coding apparatus 100 may generate a prediction block for an input block of the input videos and then, code a difference between the input block and the prediction block.

In the case of the intra mode, the intra predictor 120 may perform the spatial prediction using the pixel values of the previously coded neighboring blocks of the current block to generate the prediction block.

In the case of the inter mode, the motion predictor 111 may obtain motion information by searching a region optimally matched with the input block in a reference picture stored in the reference picture buffer 190 during a motion prediction process. The motion information including motion vector information, reference picture index information, or the like, may be coded in a coder and then, transmitted to a decoder. The motion compensator 112 may perform the motion compensation by using the motion information and the reference picture stored in the reference picture buffer 190 to generate the prediction block.

In this case, the motion information means related information used to obtain a position of a reference block that is used for the intra-picture or inter-picture prediction. The motion information may include the motion vector information indicating a relative position between the current block and the reference block, the reference picture index information indicating whether the reference block is present in any reference picture when the plurality of reference pictures are used, or the like. When a sheet of reference picture is present, the reference picture index information may not be included in the motion information. The reference block, which is a block in the reference picture, is a block including the related information corresponding to prediction values (predictors) of pixels in the current block. In the case of the inter-picture prediction, the position of the reference picture may be indicated by the motion information such as the reference picture index value, the motion vector value, or the like. The intra-picture reference block means the reference block present in the current picture. When the motion vector is coded, the position of the intra-picture reference block may be indicated by explicit motion information. In addition, the position of the intra-picture reference block may be indicated by the motion information derived using a template, or the like.

In the case of the video with serious inter-picture illumination change, for example, in the case of the picture of which the brightness is changed over time, the deterioration in image quality may occur when the illumination change is not considered at the time of coding. In this case, so as to compensate errors due to the illumination change, the coder may perform the prediction by adaptively applying weighting coefficients to the reference picture and then, using the reference picture to which the weighting coefficients are applied. The prediction method may be referred to weighted prediction. When the weighted prediction is used, parameters used for the weighted prediction, including the weighting coefficients, may be transmitted from the coder to the decoder. In this case, the coder may perform the weighted prediction using the same parameters in the reference picture unit used in the current picture.

The coder may also use as DC offset value for the current block a difference value between an average value of the pixel values of the previously coded blocks adjacent to the current block and an average value of the pixel values of neighboring blocks of the reference block. In addition, the coder may perform the prediction while considering the illumination change even at the time of predicting the motion vector. The error compensation method may be referred to as local illumination change compensation. When the local illumination change compensation method for a video with the large inter-picture illumination change is used, the inter-picture prediction is performed using the derived offset value, thereby improving the video compression performance.

The coder may perform the prediction for the current block using various motion prediction methods. Each prediction method may be applied in different prediction modes. For example, an example of the prediction mode used in the inter-picture prediction may include a skip mode, a merge mode, an advanced motion vector prediction mode, or the like. The mode performing the prediction may be determined by a rate-distortion optimization process. The coder may transmit the information on whether any mode is used for the prediction to the decoder.

The skip mode is a coding mode in which the transmission of the residual signal and the motion information that are the difference between the prediction block and the current block is skipped. The skip mode may be applied to the intra-picture prediction, inter-picture unit-directional prediction, inter-picture bi-prediction, an inter-picture or intra-picture multi-hypothesis skip mode, or the like. The skip mode applied to the inter-picture uni-directional prediction may be referred to as a p skip mode and the skip mode B applied to the intra-picture bi-prediction may be a B skip mode.

The coder in the skip mode may generate the prediction block by deriving the motion information on the current block using the motion information provided from the peripheral blocks. In addition, the value of the residual signal of the prediction block and the current block may be 0 in the skip mode. Therefore, when the motion information and the residual signal may not be transmitted from the coder to the decoder, the coder may use only the information provided from the previously coded region to generate the prediction block.

The peripheral blocks providing the motion information to the current block may be selected by various methods. For example, the motion information may be derived from the motion information on the predetermined number of peripheral blocks. The number of peripheral blocks may be 1 and may be 2 or more.

In addition, the peripheral blocks providing the motion information to the current block in the skip mode may be the same as candidate blocks used to obtain the motion information in the merge mode. Further, the coder may transmit a merge index indicating whether any of the peripheral blocks is used to derive the motion information to the decoder. In this case, the decoder may derive the motion information on the current block from the peripheral blocks indicated by the merge index. In this case, the skip mode may also be referred to a merge skip mode.

The motion vector may be obtained by a median calculation for each horizontal and vertical component. The reference picture index may be selected as a picture nearest to the current picture on a time axis, among the pictures present in a reference picture list. A method for deriving the motion information is not limited to the method and the motion information on the current block may be derived by various methods.

The subtractor 125 may generate a residual block by the difference between the input block and the generated prediction block. The transformer 130 may output transform coefficients by performing a transform on the residual block. Further, the quantizer 140 quantizes the input transform coefficients according to quantization parameters to output quantized coefficients.

The entropy coder 150 may perform entropy coding based on values calculated in the quantizer 140 or coding parameter values, or the like, calculated during the coding process to output bit streams. For the entropy coding, coding methods such as exponential golomb, context-adaptive variable length coding (CAVLC), context-adaptive binary arithmetic coding (CABAC), or the like, may be used.

When the entropy coding is applied, the entropy coding may represent symbols by allocating a small number of bits to the symbols having high occurrence probability and allocating a large number of bits to the symbols having low occurrence probability to reduce a size of the bit streams for the symbols to be coded. Therefore, the compression performance of the video coding may be increased through the entropy coding.

The quantized coefficient may be dequantized in the dequantizer 160 and inversely transformed in the inverse transformer 170. The dequantized, inversely transformed coefficients may be added to the prediction block through the adder 175 to generate a recovery block.

The recovery block passes through the filter unit 180 and the filter unit 180 may apply at least one of a deblocking filter, sample adaptive offset (SAO), and an adaptive loop filter to the recovery block or a recovered picture. The recovery block passing through the filter unit 180 may be stored in the reference picture buffer 190.

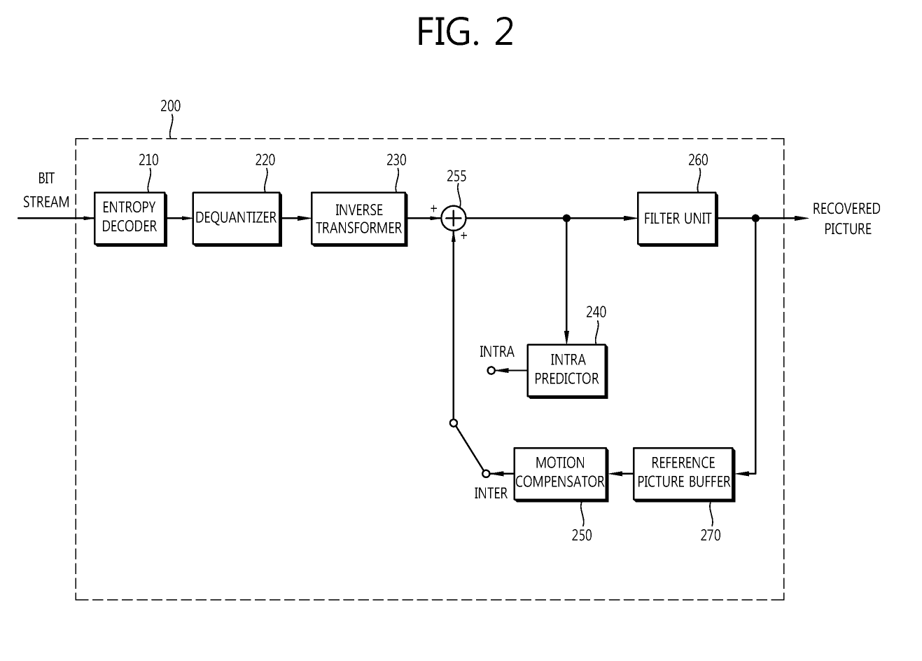

FIG. 2 is a block diagram showing a configuration of a video decoding apparatus according to an exemplary embodiment of the present invention. Referring to FIG. 2, a video decoding apparatus 200 includes an entropy decoder 210, a dequantizer 220, an inverse transformer 230, an intra predictor 240, a motion compensator 250, a filter unit 260, and a reference picture buffer 270.

The video decoding apparatus 200 may receive the bit streams output from the coder to perform the decoding with the intra mode or the inter mode and output the reconstructed video, that is, the recovered picture. In the case of the intra mode, the switch may be switched to the intra and in the case of the inter mode, the switch may be switched to the inter mode. The image decoding apparatus 200 obtains a residual block recovered from the received bit streams and generates the prediction block and then, adds the recovered residual block to the prediction block, thereby generating the reconstructed block, that is, the recovered block.

The entropy decoder 210 may perform the entropy decoding on the input bit streams according to the probability distribution to generate the symbols having the quantized coefficient type of symbols. The entropy decoding method is similar to the above-mentioned entropy coding method.

When the entropy decoding method is applied, the symbols are represented by allocating a small number of bits to the symbols having high generation probability and allocating a large number of bits to the symbols having low generation probability, thereby reducing a size of the bit streams for each symbol. Therefore, the compression performance of the video decoding may be increased through the entropy decoding method.

The quantized coefficients are dequantized in the dequantizer 220 and are inversely transformed in the inverse transformer 230. The quantized coefficients may be dequantized/inversely transformed to generate the recovered residual block.

In the case of the intra mode, the intra predictor 240 may perform the spatial prediction using the pixel values of the previously coded neighboring blocks of the current block to generate the prediction block. In the case of the inter mode, the motion compensator 250 may perform the motion compensation by using the motion information transmitted from the coder and the reference picture stored in the reference picture buffer 270 to generate the prediction block.

The decoder may use the error compensation technology such as a weighted prediction technology, a local illumination change technology, or the like, so as to prevent the deterioration in image quality due to the inter-picture illumination change. The method for compensating errors due to the illumination change is described above in the exemplary embodiment of FIG. 1.

Similar to the case of the above-mentioned coder, the decoder may perform the prediction for the current block using various prediction methods. Each prediction method may be applied in different prediction modes. For example, an example of the prediction mode used in the inter-picture prediction may include the skip mode, the merge mode, the advanced motion vector prediction mode, or the like. The decoder may receive the information on whether any mode is used for the prediction from the coder.

In particular, in the skip mode, the decoder may generate the prediction block by deriving the motion information on the current block using the motion information provided from the peripheral blocks. In addition, the value of the residual signal of the prediction block and the current block may be 0 in the skip mode. Therefore, the decoder may not receive the separate motion information and residual signal and may generate the prediction block using only the information provided from the previously coded region. The details of the skip mode are similar to ones described in the coder.

The recovered residual block and the prediction block are added through the adder 255 and the added block passes through the filter unit 260. The filter unit 260 may apply at least one of the deblocking filter, the SAO, and the ALF to the recovery block or the recovered picture. The filter unit 260 outputs the reconstructed videos, that is, the recovered picture. The recovered picture may be stored in the reference picture buffer 270 so as to be used for the inter-picture prediction.

In the skip mode described above in the exemplary embodiments of FIGS. 1 and 2, the motion information and the residual signal are not transmitted to the decoder and therefore, the transmitted information amount may be smaller than the case in which other prediction modes are used. Therefore, when the frequency selecting the skip mode by the rate-distortion optimization process is high, the video compression efficiency may be improved.

In the skip mode, the coder and the decoder use only the information on the previous coded/decoded region to perform the prediction. In the skip mode, the prediction is performed by only the motion information on the peripheral blocks and the pixel values of the reference block and therefore, the rate required for the coding may be minimal or the distortion may be increased, as compared with other modes in terms of the rate-distortion optimization. In the case of the video with the large inter-picture illumination change, since the inter-picture distortion is very large, it is less likely for the skip mode to be selected as the optimized prediction mode of the current block. In addition, when the coding/decoding are performed at a low bit rate, that is, even when the quantization/dequantization are performed using a large quantization step, the inter-picture distortion is increased and therefore, it is less likely for the skip mode to be selected as the optimized prediction mode of the current block.

When the local illumination change compensation is used in other inter-picture prediction modes other than the skip mode, the error compensation prediction is performed on the blocks to which the skip mode is applied to the prediction mode while considering the illumination change. In addition, the error compensation may be reflected even in the case of deriving the motion vectors of the blocks. In this case, provided that the coding is performed on the current block with the skip mode, the motion vector values obtained from the peripheral blocks may be values reflecting the error compensation and the peripheral blocks may have DC offset values other than 0 and the peripheral blocks may have the DC offset values other than 0. However, in the skip mode, the pixel value of the reference block is used as the prediction value of the current block pixel as it is without the separate motion compensation and therefore, the error compensation may not be reflected for the prediction value. In this case, it is highly likely to increase the inter-picture distortion in the skip mode. Therefore, when the error compensation such as mean-removed sum of absolute difference (MRSAD), or the like, is used to reflect the illumination change in other inter-picture prediction modes other than the skip mode, it is less likely for the skip mode to be selected as the optimized prediction mode of the current block.

Therefore, in order to increase the rate in which the skip mode is selected as the optimized prediction mode, the skip mode prediction method using the error compensation may be provided.

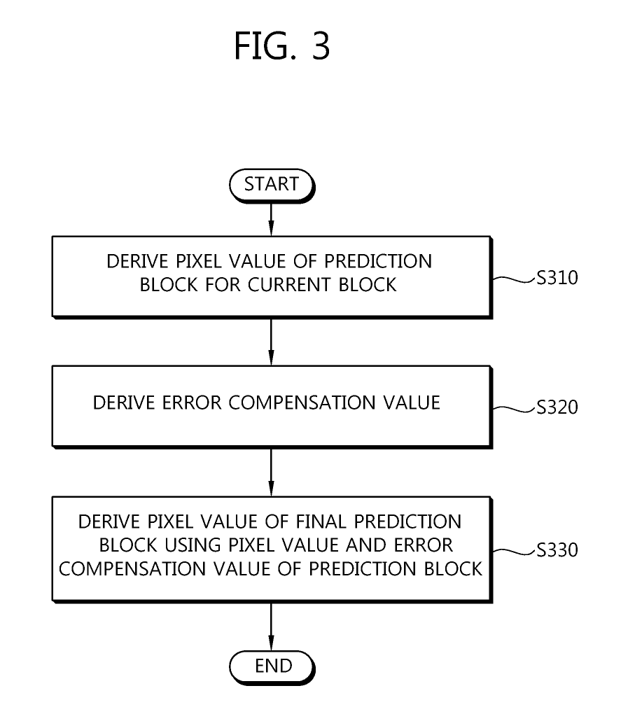

FIG. 3 is a flow chart schematically showing the skip mode prediction method using the error compensation according to an exemplary embodiment of the present invention. In the exemplary embodiment of FIG. 3, the coder and the decoder perform the prediction for the current block in the skip mode. As the exemplary embodiment, the prediction according to the exemplary embodiment of FIG. 3 may be performed in the intra predictor, the motion predictor, and/or the motion compensator in the coder and the decoder.

Hereinafter, the exemplary embodiments of the present invention may be similarly applied to the coder and the decoder and the exemplary embodiments of the present invention mainly describe the decoder. In the decoder, the previously coded block rather than the previously decoded block to be described later may be used for the prediction of the current block. The previously coded block means the block coded prior to performing the prediction for the current block and/or the coding and the previously decoded block means the block decoded prior to performing the prediction for the current block and/or the decoding.

Referring to FIG. 3, the decoder derives the pixel values of the prediction block for the current block from the previously decoded blocks (S310). The prediction block means a block generated by performing the prediction for the current block.

The decoder may derive the motion information on the current block by using the motion information on the previously decoded blocks. When the motion information is derived, the pixel value of the reference block in the reference picture may be derived by using the derived motion information. In the exemplary embodiment of FIG. 3, the decoder performs the prediction in the skip mode and therefore, the pixel value of the reference block may be the pixel value of the prediction block. The reference block may be 1 and may be two or more. When the reference block is two or more, the decoder may generate at least two prediction blocks by separately using each reference block and may derive the pixel values of the prediction block for the current block by using the weighted sum of the pixel values of at least two reference blocks. In this case, the prediction block may also be referred to as the motion prediction block.

The decoder derives a sample value of the error compensation block for the current block (S320). The error compensation block may the same size as the prediction block. Hereinafter, the error compensation value has the same meaning as the sample value of the error compensation block.

The decoder may derive the error parameters for the error model of the current block by using the information included in the neighboring blocks of the current blocks and/or the error parameters, or the like, included in the neighboring blocks of the current block. When the error parameters are derived, the decoder may derive the error compensation value of the current block by using the error model information and the derived error parameter information. In this case, the decoder may derive the error compensation value by using the motion information, or the like, together with the error parameter information and the error model information when the reference block is two or more.

The decoder derives the pixel values of the final prediction block for the current block by using the pixel value and the error compensation value of the prediction block (S330). The method for deriving the pixel values of the final prediction blocks may be changed according to the number of reference blocks or the coding/decoding method of the current picture.

The details of each process of the exemplar embodiments of FIG. 3 will be described below.

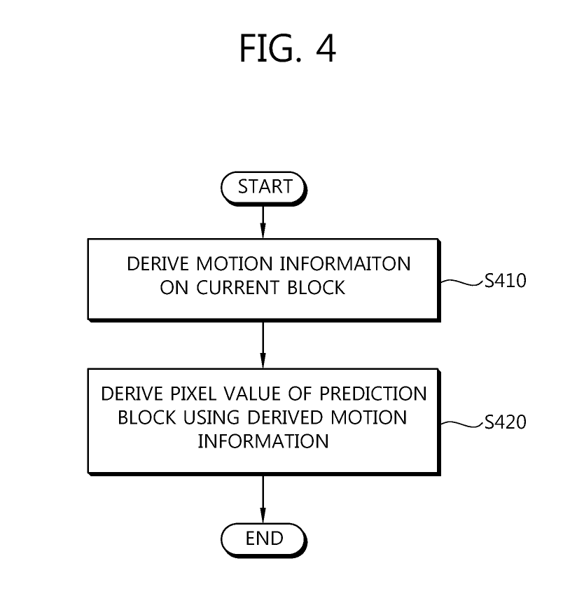

FIG. 4 is a flow chart schematically showing a method for deriving pixel values of a prediction block according to an exemplary embodiment of the present invention.

Referring to FIG. 4, the decoder derives the motion information on the current block from the previously decoded blocks (S410). The motion information may be used to derive the pixel value of the prediction block for the current block.

The decoder may derive the motion information from the motion information on the neighboring blocks of the current block. In this case, the peripheral blocks, which are blocks present in the current picture, are previously decoded blocks. The decoder may derive one motion information and may derive at least two motion information. When the motion information is two or more, at least two reference blocks may be used to predict the current block according to the number of motion information.

The decoder may derive the motion information by using the motion information on the neighboring blocks of the current block and the motion information on the neighboring blocks of the collocated block. In this case, the coder may derive one or two or more motion information. When the motion information is two or more, at least two reference blocks may be used to predict the current block according to the number of motion information.

The decoder may derive the motion information by using at least one of the above-mentioned methods and the details of the method for deriving motion information for the above-mentioned cases will be described below.

The decoder derives the pixel values of the prediction block by using the derived motion information (S420).

In the skip mode, the values of the residual signals of the reference block and the current block may be 0 and the pixel value of the reference block in the reference picture may be the pixel value of the prediction block for the current block as it is when the reference block is 1.

The reference block may be a block in which the collocated block in the reference picture for the current block moves by the value of the motion vector. In this case, the pixel value of the prediction block for the current block may be the pixel value of the block in which the block present at the same position as the prediction block moves by the value of the motion vector in the reference picture, that is, the reference block. The pixel value of the prediction block for the current block may be represented by the following Equation 1.

P_{cur}(t0,X,Y)=P_{ref}(X+MV(x),Y+MV(y)) [Equation 1]

Where P_{cur} represents the pixel value of the prediction block for the current block and P_{ref} represents the pixel value of the reference block. x represents a coordinate in an x-axis direction of the pixel in the current block and y represents a coordinate in a y-axis direction of the pixel in the current block. In addition, MV(x) represents an x-axis direction size of the motion vector and MV(y) represents a y-axis direction size of the motion vector.

When the reference block is two or more, the pixel value of the prediction block for the current block may be derived by using the weighted sum of the pixel values of the reference blocks. That is, when N reference blocks are used to generate the prediction block, the weighted sum of the pixel values of the N reference blocks may be the pixel value of the prediction block. If the motion information on the derived current block is represented by {{ref_idx1, MV1}, {ref_idx2, MV2}, . . . , {ref_idxn, MVn}} when the reference block is N, the pixel value of the prediction block derived by using only the reference block corresponding to i-th motion information may be represented by the following Equation 2.

P_{cur}_{_{—}}_{ref i}(t0,X,Y)=P_{ref}_{_{—}}ᵢ(X+MVᵢ(x),Y+MVᵢ(y)) [Equation 2]

Where Pcur_{—}_{^{ref}}_i represents the pixel value of the prediction block derived by using only the reference block corresponding to the i-th motion information and Pref_{—}_{ⁱ} represents the pixel value of the reference block corresponding to the i-th motion information. In addition, MVᵢ(x) represents an x-axis direction size of a first motion vector and MVᵢ(y) represents a y-axis direction size of the first motion vector.

In this case, when the pixel value of the prediction block for the current block derived by the weighted sum of the pixel values of the N reference blocks may be represented by the following Equation 3.

P_{cur}_{_{—}}_{ref}(t0,X,Y)=Σᵢ₌₁^{N}(wᵢP_{ref}_{_{—}}ᵢ(X+MVᵢ(x),Y+MVᵢ(y))) [Equation 3]

Where P_{cur}_{_{—}}_{ref} represents the pixel value of the prediction block for the current block and wᵢ represents the weighting value applied to the pixel value of the reference block corresponding to the i-th motion information. In this case, the sum of the weighting values may be 1. As the exemplary embodiment, in the bi-prediction in which two reference blocks are used, w1=½ and w2=½ when N=2.

In the exemplary embodiment of the above-mentioned Equation 3, as the weighting values applied to the pixel values of each reference block, the predetermined fixed value may be used. In addition, each weighting value may be variably set according to the distance between the reference picture including the reference block to which the weighting values are applied and the current picture. In addition, each weighting value may be variably set according to the spatial position of the pixel in the prediction block. The spatial position of the pixel in the prediction block may be the same as the spatial position of the pixel presently predicted in the current block. When the weighting values are variably set according to the spatial position of the pixel in the prediction block, the pixel value of the prediction block for the current block may be represented by the following Equation 4.

P_{cur}_{_{—}}_{ref}(t0,X,Y)=Σᵢ₌₁^{N}(wᵢ(X,Y)P_{ref}_{_{—}}ᵢ(X+MVᵢ(x),Y+MVᵢ(y)))

Where the weighting value wᵢ (X, Y) is a weighting value applied to the pixel value of the reference block corresponding to the i-th motion information. Referring to Equation 4, the weighting value wᵢ (X, Y) may have different values according to the coordinates (X, Y) of the pixel in the prediction block.

The decoder may use at least one of the above-mentioned methods in deriving the pixel values of the prediction block using the derived motion information.

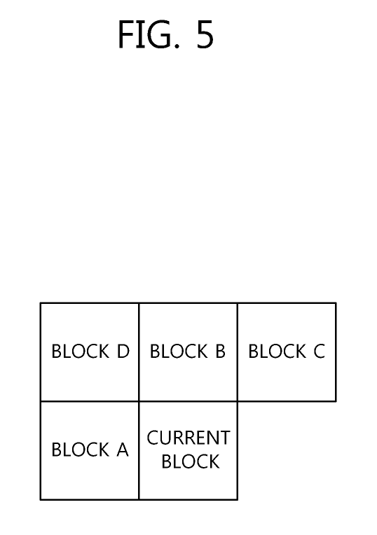

FIG. 5 is a conceptual diagram schematically showing an example of peripheral blocks to the current block, which are used at the time of deriving motion information in the exemplary embodiment of FIG. 4. The neighboring blocks of the current block, which are a block in the current picture, are a previously decoded block.

The motion information may include the information on the position of the reference block for the current block. The decoder may derive one motion information and may also derive at least two motion information. When the motion information is two or more, at least two reference blocks may be used to predict the current block according to the number of motion information.

Referring to FIG. 5, the decoder may derive the motion information on the current block by using the motion information on block A, block B, and block C. As the exemplary embodiments, the decoder may select the picture nearest to the picture including the current block on a time axis among the pictures included the reference picture list as the reference picture. In this case, the decoder may select only the motion information indicating the selected reference picture among the motion information on block A, block B, and block C and may use the motion information to derive the motion information on the current block. The decoder may obtain the median of the motion information selected for the horizontal and vertical component. In this case, the median may be the motion vector of the current block.

The positions and numbers of the peripheral blocks used to derive the motion information on the current block are not limited to the exemplary embodiment of the present invention and the peripheral blocks of positions and numbers different from the exemplary embodiment of FIG. 5 may be used to derive the motion information according to the implementation.

The motion information on the peripheral block may be information coded/decoded by the merge method. In the merge mode, the decoder may use the motion information included in the block indicated by the merge index of the current block as the motion information on the current block. Therefore, when the peripheral block is coded/decoded in the merge mode, the method for deriving the motion information according to the exemplary embodiment of the present invention may further include the process of deriving the motion information on the peripheral block by the merge method.

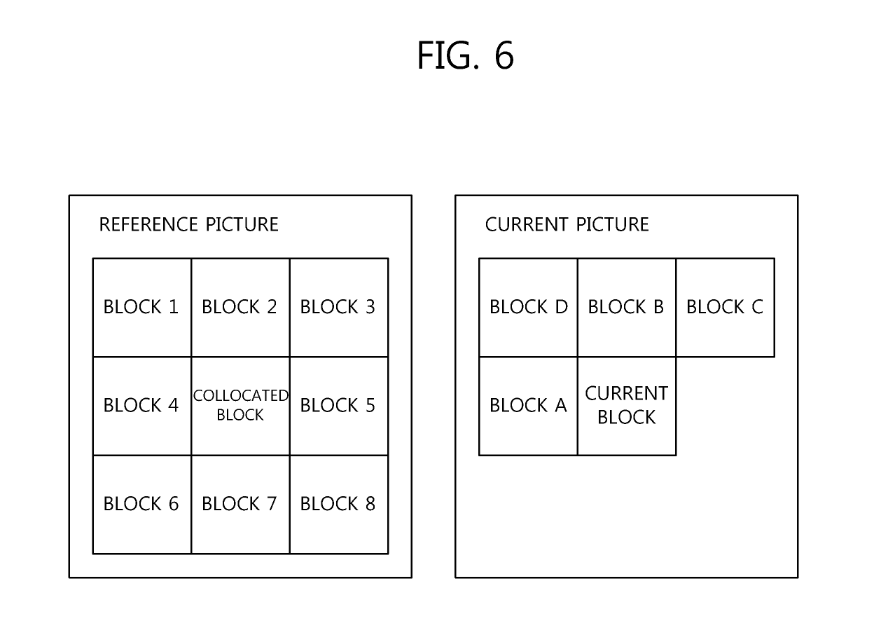

FIG. 6 is a conceptual diagram schematically showing the peripheral blocks to the current block and peripheral blocks of the collocated block in a reference picture, which are used at the time of deriving the motion information in the exemplary embodiment of FIG. 4.

As described above in the exemplary embodiment of the present invention of FIG. 4, the decoder may derive the motion information by using the motion information on the neighboring blocks of the current block and the motion information on the neighboring blocks of the collocated block in the reference picture.

Referring to FIG. 6, all the blocks in the reference picture may be the previously decoded block. Therefore, all the neighboring blocks of the collocated block in the reference picture may be selected as the block used to derive the motion information on the current block. The neighboring blocks of the current block, which are a block in the current picture, are the previously decoded block.

In order to derive the motion information on the current block, the median of the blocks may be used as the exemplary embodiment of the present invention. In addition, in order to derive the motion information on the current block, a motion vector competition method may be used. When the motion information prediction coding is performed in the motion vector competition method, the plurality of prediction candidates may be used. The decoder may select the optimized prediction candidate in consideration of the rate control costs among the plurality of prediction candidates and perform the motion information prediction coding using the selected prediction candidates. In this case, the information on which any of the plurality of prediction candidates is selected may be further needed. An example of the motion vector competition method may include, for example, advanced motion vector prediction (AMVP), or the like.

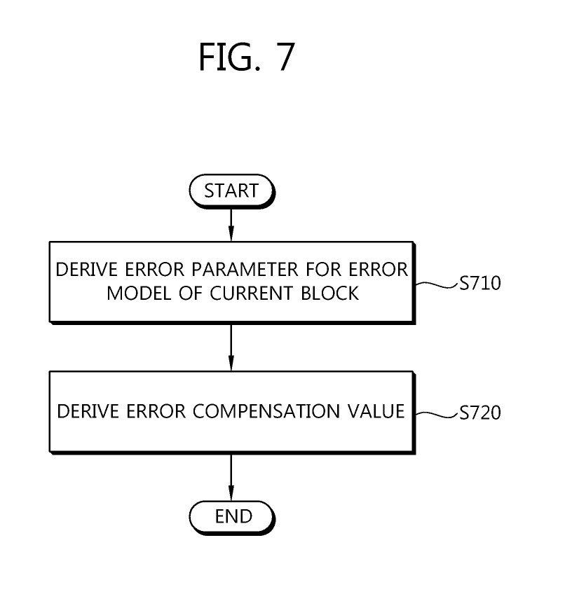

FIG. 7 is a flow chart schematically showing a method of deriving an error compensation value according to an exemplary embodiment of the present invention.

Referring to FIG. 7, the decoder derives the error parameters for the error model of the current block (S710).

In order to derive the error compensation value according to the exemplary embodiment of the present invention, the error model obtained by modeling the errors between the current block and the reference block may be used. There may be various types of the error models used for the error compensation of the current block. For example, there may be a 0-order error model, a 1-order error model, an N-order error model, a non-linear error model, or the like.

The error compensation value of the 0-order error model may be represented by the following Equation 5 as the exemplary embodiment of the present invention.

Error compensation value(x,y)=b [Equation 5]

Where (x, y) is a coordinate of the pixel to be predicted in the current block. b, which is the DC offset, corresponds to the error parameter of the 0-order error model. When the error compensation is performed using the 0-order error model, the decoder may derive the pixel value of the final prediction block by using the pixel value and the error compensation value of the prediction block. This may be represented by the following Equation 6.

Pixel value of final prediction block(x,y)=pixel value of prediction block(x,y)+b [Equation 6]

The error compensation value of the 1-order error model may be represented by the following Equation 7 as the exemplary embodiment of the present invention.

Error compensation value(x,y)=(a−1)*pixel value of prediction block(x,y)+b [Equation 7]

Where a and b correspond to the error parameters of the 1-order error model. When the 1-order error model is used, the decoder obtains the error parameters a and b and then, performs the compensation. When the error compensation is performed using the 1-order error model, the pixel value of the derived final prediction block may be represented by the following Equation 8.

Pixel value of final prediction block(x,y)=pixel value of prediction block(x,y)+error compensation value(x,y)=a*pixel value of prediction block(x,y)+b [Equation 8]

The error compensation value of the N-order error model and the pixel value of the final prediction block may be represented by the following Equation 9 as the exemplary embodiment of the present invention.

Error compensation value(x,y)=an*P(x,y)n+an−1*P(x,y)n−1+ . . . +(a−1)P(x,y)+b [Equation 9]

Pixel value of final prediction block(x,y)

=Pixel value of prediction block(x,y)+error compensation value(x,y)

=an*P(x,y)n+an−1*P(x,y)n−1+ . . . +a*P(x,y)+b

Where P means the pixel value of the prediction block for current block.

The decoder may use other non-linear error models. In this case, the error compensation value may be represented by the following Equation 10.

Error compensation value(x,y)=f(P(x,y)) [Equation 10]

Where f may be any function rather than linearity.

The error parameters used within the current block may be the same value as described above in the exemplary embodiments of the present invention. However, different error parameters may also be used according to the position of the pixel to be predicted in the current block. The decoder may also derive the final error compensation by applying the weighting values to the error compensation value derived by using the same error parameter according to the spatial position of the pixel to be predicted in the current block. In this case, the final error compensation value may be changed according to the position in the current block of the pixel to be predicted. The final error compensation value may be represented by the following Equation 11.

Final error compensation value(x,y)=error compensation value derived using same error parameter(x,y)*w(x,y) [Equation 11]

Where w means the weighting value.

The decoder may derive the error parameter according to the error model of the current block. At the process of deriving the error parameters, the decoder may not obtain the actual pixel value of the current block and therefore, may derive the error parameters of the error model for the present model by using the information included in the neighboring blocks of the current block. In this case, the neighboring blocks of the current block, which are the peripheral blocks adjacent to the current block, mean the previously coded blocks.

Upon deriving the error parameters, the decoder may use the pixel values of the neighboring blocks of the current block, the pixel value of the reference block and/or only the pixel values of the neighboring pixels of the reference block. In addition, upon deriving the error parameters, the decoder may use both of the pixel values and the motion information and/or the coding mode information, or the like, included in the neighboring blocks of the current block, and may use both of the motion information and/or the coding mode information, or the like, included in the current block.

When the 0-order error model is used for the error compensation, the pixel value of the neighboring blocks of the current block, the pixel value of the reference block, and/or only the pixel values of the peripheral pixels of the reference block are used to derive the error parameters, the error parameter b may be represented by the following Equation 12 as the exemplary embodiment of the present invention.

b=Mean(Current Block′)−Mean(Reference Block′) [Equation 12]

Where mean (Current Block′) may be an average of the pixel values of the previously coded block as the neighboring blocks of the current block. At the process of deriving the error parameters, the decoder may not obtain an average of the pixel values of the current block and therefore, may obtain the average of the pixel values of the neighboring blocks of the current block so as to derive the error parameters. The mean (Reference Block′) may be an average of the pixel values of the reference block or an average of the pixel values of the neighboring blocks of the reference block. At the process of deriving the error parameters, the decoder may obtain the pixel value of the reference block and therefore, may use the pixel values of the neighboring block of the reference block and the pixel values of the reference block to derive the error parameters.

The detailed exemplary embodiments of the method for deriving the error parameter for the 0-order error model will be described below.

When the 1-order error model is used for the error compensation, the error parameter a may be obtained by the following Equation 13 according to the exemplary embodiment of the present invention.

a=Mean(Current Block′)/Mean(Reference Block′) [Equation 13]

Where Mean(Current Block′) and Mean(Reference Block′) have the same meaning as Mean(Current Block′) and Mean(Reference Block′) of Equation 12. In this case, the error parameter b may be obtained by the same method as the 0-order error model.

When the 1-order error model is used for the error compensation, the decoder may derive the error parameters by using the method used in the weighted prediction (WP) according to another exemplary embodiment of the present invention. In this case, the error parameter a may be obtained by the following Equation 14.

$${w}^{Y} [ n ] = \{ \begin{matrix}⌊ {2}^{5} \cdot ( \frac{{v\_cur}^{Y}}{{v\_ref}^{Y} [ n ]} ) + 0.5 ⌋ & {v\_ref}^{Y} [ n ] \neq 0 \\ {2}^{5} & {v\_ref}^{Y} [ n ] = 0\end{matrix} \\ {w}^{Y} [ n ] = iclip 3 ( - 128 , 127 , {w}^{Y} [ n ] ) \\ {m\_cur}^{Y} = \frac{1}{W \cdot H} {\sum }_{i = 0}^{H - 1} {\sum }_{j = 0}^{W - 1} {c}_{ij}^{Y} \\ {v\_cur}^{Y} = {\sum }_{i = 0}^{H - 1} {\sum }_{j = 0}^{W - 1} \vert {c}_{ij}^{Y} - ( {m\_cur}^{Y} ) \vert \\ {m\_ref}^{Y} [ n ] = \frac{1}{W \cdot H} {\sum }_{i = 0}^{H - 1} {\sum }_{j = 0}^{W - 1} {{r}^{Y} [ n ]}_{ij} \\ {v\_ref}^{Y} [ n ] = {\sum }_{i = 0}^{H - 1} {\sum }_{j = 0}^{W - 1} \vert {{r}^{Y} [ n ]}_{ij} - ( {m\_ref}^{Y} [ n ] ) \vert \qquad [ Equation 14 ]$$

Where W^{y}[n], which is the weighting value, represents the error parameter a. In addition, H represents a height of the current block and the reference block and w represents a width of the current block and the reference block. c^{Y}ᵢⱼ represents a luma pixel value in the current frame and r^{y}[n]ᵢⱼ represents a luma pixel value in the reference frame. In addition, a value of iclip3 (a, b, c) is a when c is smaller than a and is b when c is larger than b and otherwise, is c.

In addition, when the method used in the weighted prediction is used to derive the error parameters, the error parameter b may be obtained by the following Equation 15.

$${offset}^{Y} [ n ] = ⌊ {m\_cur}^{Y} - ( {w}^{Y} [ n ] \cdot \frac{{m\_ref}^{Y} [ n ]}{{2}^{5}} + 0.5 ) ⌋ \\ {offset}^{Y} [ n ] = iclip 3 ( - 128 , 127 , {offset}^{Y} [ n ] ) \qquad [ Equation 15 ]$$

Where offset Y[n], which is the offset value, represents the error parameter b.

When the error parameter information on the neighboring blocks of the current block is present, the decoder may also derive the error parameters of the current block by using the error parameters of the neighboring blocks of the current block.

According to the exemplary embodiment of the present invention, when one peripheral block having the error parameter information as the peripheral block having the same motion vector as the current block is present, the decoder may use the error parameter as the error parameter of the current block. According to the exemplary embodiment of the present invention, when at least two peripheral blocks having the error parameter information as the peripheral block having the same motion vector as the current block are present, the decoder may obtain the weighted sum of the error parameters of the peripheral blocks and may use the obtained weighted sum as the error parameter of the current block. In addition, the decoder may use the error parameters of the neighboring blocks of the current block as an initial prediction value upon deriving the error parameters.

The decoder may also derive the error parameters using the additional information transmitted from the coder. According to the exemplary embodiment of the present invention, the coder may further transmit the difference information between the actual error parameter and the prediction error parameter to the decoder. In this case, the decoder may derive the actual error parameter by adding the transmitted difference information to the prediction error parameter information. In this case, the prediction error parameter means the error parameter predicted in the coder and the decoder. The parameter information further transmitted from the coder is not limited to the difference information and may have various types.

Referring again to FIG. 7, the decoder derives the error compensation value for the current block by using the error model and the derived error parameter (S720).

When the used reference block is 1, the decoder may use the error compensation value derived by the error model and the error parameter as the error compensation value of the current block as it is.

When the used reference block is two or more, the decoder may generate at least two prediction blocks by separately using each of the reference blocks. In this case, the decoder may derive the error compensation value for each prediction block by deriving the error parameters for each prediction block. Hereinafter, the error compensation values for each prediction block may be referred to as the error block value. The decoder may derive the error compensation value for the current block by the weighted sum of the error block values.

According to the exemplary embodiment of the present invention, the weighting values may be set by using the distance information between the current block and the prediction blocks corresponding to each reference block. In addition, when the reference block is at least two, at least two motion information indicating each reference block may be present and the weighting value may also be set by using the directivity information on each motion information. In addition, the weighting value may also be set by using the directivity information between respective motion information and the size information of each motion information, together. When at least two reference blocks are used, the detailed exemplary embodiment of the weighting value used to derive the error compensation value will be described below.

The weighting value may be obtained by using at least one of the above-mentioned exemplary embodiments. In addition, the method for defining the weighting value is not limited to the above-mentioned exemplary embodiments and therefore, the weighting value may be set by various methods according to the implementations.

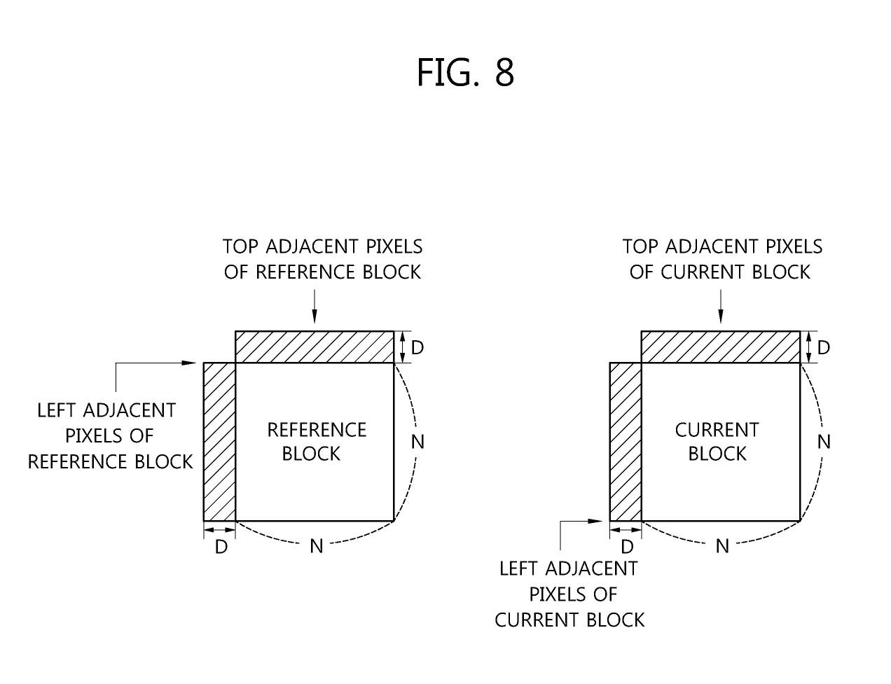

FIG. 8 is a conceptual diagram schematically showing an example of a method of deriving error parameters for a 0-order error model according to an exemplary embodiment of the present invention. In the exemplary embodiment of the present invention of FIG. 8, the height and the width of the current block and the reference block are represented. In addition, D represents the number of lines of the peripheral pixels adjacent to the current block and the reference block. For example, D may have values such as 1, 2, 3, 4, . . . , N, or the like.

Referring to FIG. 8, the decoder may use the pixel values of the neighboring pixels of the current block and the pixel values of the neighboring pixels of the reference block to derive the error parameters. In this case, the error parameter of the 0-order model may be represented by the following Equation 16.

offset=Mean(Current Neighbor)−Mean(Ref. Neighbor) [Equation 16]

Herein, the offset represents the error parameters of the 0-error model. In addition, Mean(Current Neighbor) represents an average of the pixel values of the pixels adjacent to the current block At the process of deriving the error parameters, the decoder may not obtain an average of the pixel values of the current block and therefore, may obtain the average of the pixel values of the neighboring pixels of the current block so as to derive the error parameter. Mean (Ref. Neighbor) represents the average of the pixel values of the neighboring pixels of the reference block.

Referring to Equation 16, the decoder may use the difference value between the average of the pixel values of the neighboring pixels of the current block and the average of the pixel values of the neighboring pixels of the reference block as the error parameter values. In this case, the range of the pixels used to derive the error parameters may be variously set. According to the exemplary embodiment of the present invention, when D=1, only the pixel values included in the lines just adjacent to the current block and/or the reference block may be used to derive the error parameters.

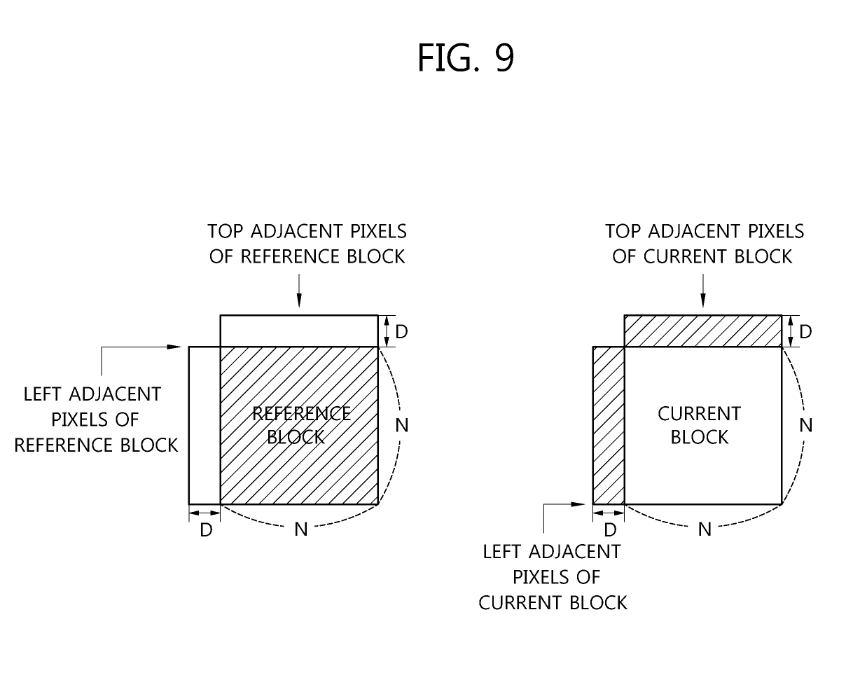

FIG. 9 is a conceptual diagram schematically showing another example of a method of deriving error parameters for a 0-order error model according to the exemplary embodiment of the present invention. In the exemplary embodiment of FIG. 9, N and D have the same meaning as N and D in the exemplary embodiment of FIG. 8.

Referring to FIG. 9, the decoder may use the pixel values of the neighboring pixels of the current block and the pixel values of the pixels in the reference block to derive the error parameters. In this case, the error parameter of the 0-order model may be represented by the following Equation 17.

offset=Mean(Current Neighbor)−Mean(Ref.Block) [Equation 17]

Where mean (Ref. Block) represents the average of the pixel values of the pixels in the reference block.

Referring to Equation 17, the decoder may derive the difference value between the average of the pixel values of the neighboring pixels of the current block and the average of the pixel values of the pixels in the reference block as the error parameter values. In this case, similar to the exemplary embodiment of FIG. 8, the range of the used pixels may be variously set.

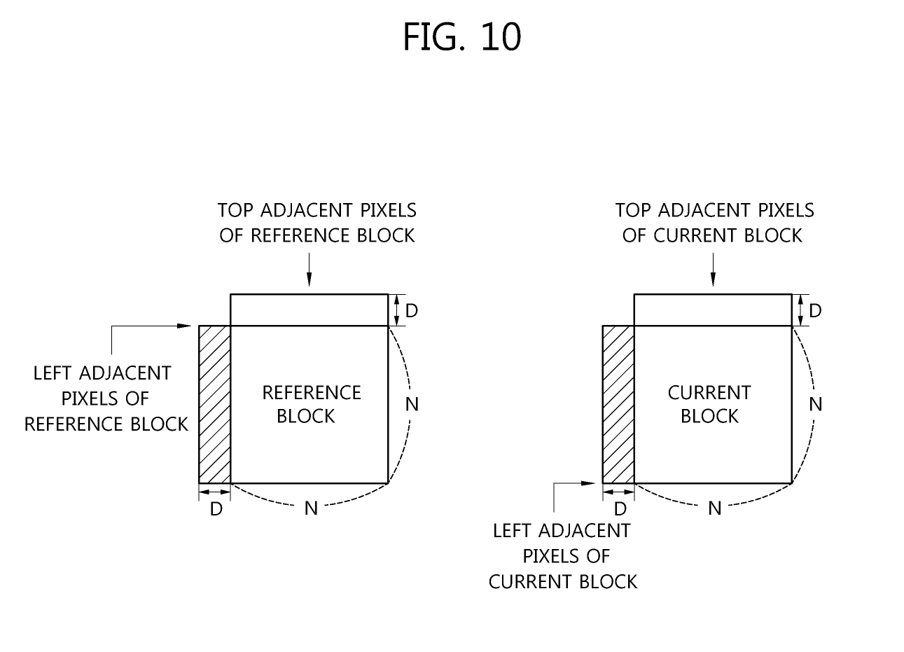

FIG. 10 is a conceptual diagram schematically showing another embodiment of a method of deriving error parameters for a 0-order error model according to an exemplary embodiment of the present invention. In the exemplary embodiment of FIG. 10, N and D have the same meaning as N and D in the exemplary embodiment of FIG. 8.

Referring to FIG. 10, the decoder may use the pixel values of the neighboring pixels of the current block and the pixel values of the neighboring pixels of the reference block to derive the error parameters. In addition, as descried in the exemplary embodiment of FIG. 7, the decoder may also derive the error parameters by using both of the pixel values and the derived motion information for the current block. In this case, the error parameter of the 0-order model may be represented by the following Equation 18.

offset=Mean(weight*Current Neighbor)−Mean(weight*Ref. Neighbor) [Equation 18]

In addition, Mean (weight*Current Neighbor) represents the weighting average of the pixel values of the peripheral pixels adjacent to the current block Mean (weight*Ref Neighbor) represents the weighting average of the pixel values of the neighboring pixels of the reference block.

Referring to Equation 18, the decoder may derive the difference value between the weighting average of the pixel values of the neighboring pixels of the current block and the weighting average of the pixel values of the neighboring pixels of the reference block as the error parameter values.

The weighting value may be obtained using the directivity of the derived motion information for the current block and/or the neighboring blocks of the current block. Referring to the exemplary embodiment of FIG. 10, when the motion vector has only the horizontal component, the decoder may use only the pixels values included in the current block and the left block of the reference block to derive the error parameters. In this case, when the weighting value of 1 may be applied to the pixel values of the left blocks and the weighting value of 0 may be applied to the pixel values of the top block.

In this case, similar to the exemplary embodiment of FIG. 8, the range of the used pixels may be variously set.

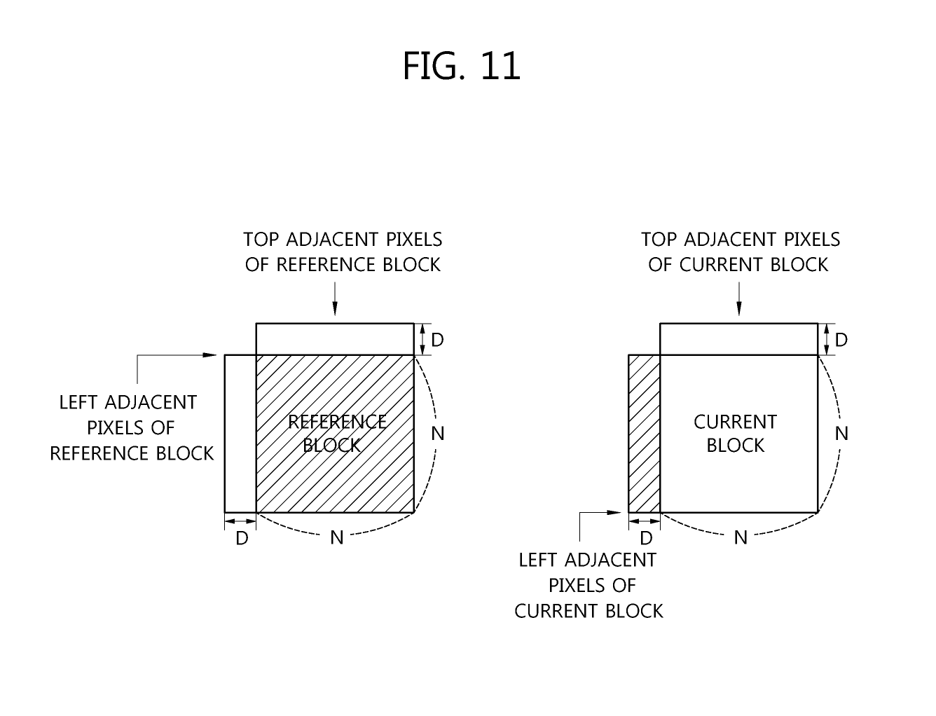

FIG. 11 is a conceptual diagram schematically showing another embodiment of a method of deriving error parameters for a 0-order error model according to an exemplary embodiment of the present invention. In the exemplary embodiment of FIG. 11, N and D have the same meaning as N and D in the exemplary embodiment of FIG. 8.

Referring to FIG. 11, the decoder may use the pixel values of the neighboring pixels of the current block and the pixel values of the pixels in the reference block to derive the error parameters. In this case, the error parameter of the 0-order model may be represented by the following Equation 19.

offset=Mean(weight*Current Neighbor)−Mean(Ref.Block) [Equation 19]

Referring to Equation 19, the decoder may derive the difference value between the weighting average of the pixel values of the neighboring pixels of the current block and the weighting average of the pixel values of the pixels in the reference block as the error parameter values.

The weighting value may be obtained using the directivity of the derived motion information for the current block and/or the neighboring blocks of the current block. Referring to the exemplary embodiment of FIG. 11, when the motion vector has only the horizontal component, the decoder may use only the pixel values of the pixels included in the left block among the pixels values of the pixels adjacent to the current block to derive the error parameters. In this case, when the weighting value of 1 may be applied to the pixel values of the left blocks and the weighting value of 0 may be applied to the pixel values of the top block.

In this case, similar to the exemplary embodiment of FIG. 8, the range of the used pixels may be variously set.

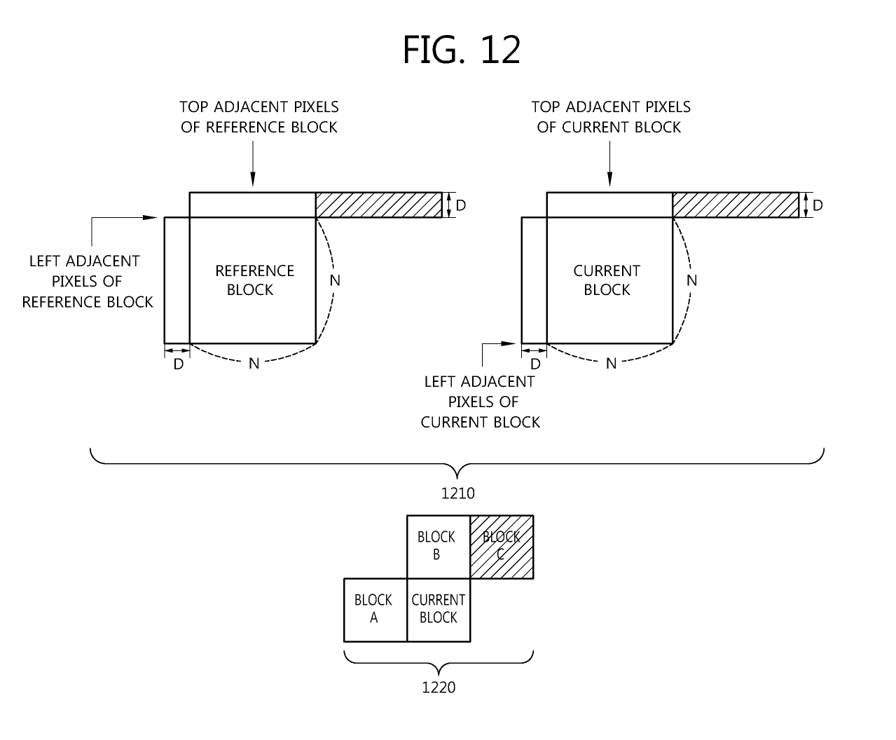

FIG. 12 is a conceptual diagram schematically showing another example of a method of deriving error parameters for a 0-order error model according to the exemplary embodiment of the present invention. In the exemplary embodiment of FIG. 12, N and D have the same meaning as N and D in the exemplary embodiment of FIG. 8.

Referring to S1210 of FIG. 12, the decoder may use the pixel values of the neighboring pixels of the current block and the pixel values of the neighboring pixels of the reference block to derive the error parameters. In this case, the error parameter of the 0-order model may be represented by the following Equation 20.

offset=Mean(weight*Current Neighbor)−Mean(weight*Ref. Neighbor) [Equation 20]

Mean (weight*Current Neighbor) represents the weighting average of the pixel values of the neighboring pixels of the current block. Mean (weight*Ref Neighbor) represents the weighting average of the pixel values of the neighboring pixels of the reference block. In the exemplary embodiment of FIG. 12, the neighboring pixels of the current block may be the pixel values included in block C shown in S1220 of FIG. 12. In addition, the neighboring pixels of the reference block may be the pixels included in the block in the reference picture corresponding to block C. Hereinafter, block C in the exemplary embodiment of FIG. 12 is referred to as the top left block of the current block and the block in the reference picture corresponding to block C is referred to as the top left block of the reference block.

Referring to Equation 20, the decoder may derive the difference value between the weighting average of the pixel values of the neighboring pixels of the current block and the weighting average of the pixel values of the neighboring pixels of the reference block as the error parameter values.

The weighting value may be obtained using the directivity of the derived motion information for the current block and/or the neighboring blocks of the current block. Referring to the exemplary embodiment of FIG. 12, when the derived motion vector for the current block is the same as the motion vector of block C shown in S1220 of FIG. 12, the decoder may use only the pixel values of the pixels included in the top left block of the current block and the peripheral block to derive the error parameters. For example, when the weighting value of 1 may be applied to the pixel values of the top left blocks and the weighting value of 0 may be applied to the pixel values of the top block and the left block. In this case, referring to S1210 of FIG. 12, the top block of the current block is block B, the left block of the current block is block A, and the top left block of the current block is block C. The top block of the left block, the left block, and the top left block each are the blocks in the reference picture corresponding to block B, block A, and block C.

In this case, similar to the exemplary embodiment of FIG. 8, the range of the used pixels may be variously set.

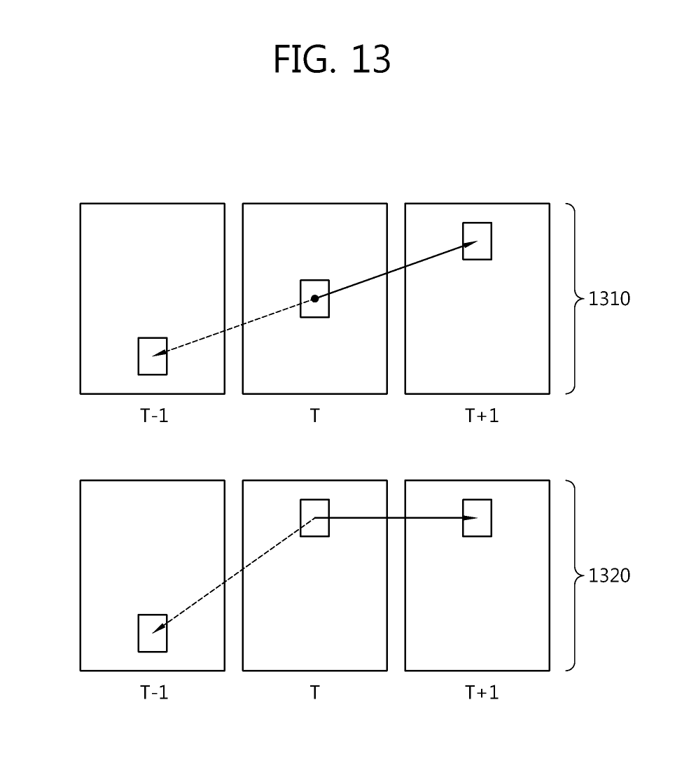

FIG. 13 is a conceptual diagram schematically showing an embodiment of a motion vector used for deriving error compensation values using a weight in the exemplary embodiment of FIG. 7. FIG. 13 represents the exemplary embodiment in the case in which the reference block is two. T−1, T, and T+1 mean the time for each picture. In the exemplary embodiment of FIG. 13, the picture of time T represents the current picture and the block in the current picture represents the current block. In addition, the picture of time T−1 and T+1 represents the reference picture and the block in the reference picture represents the reference block. In addition, in the exemplary embodiment of FIG. 13, the motion vector of the current block indicating the reference block in the reference picture of time T−1 is referred to as the motion vector of reference picture list 0 and the motion vector of the current block indicating the reference block in the reference picture of time T+1 is referred to as the motion vector of the reference picture list 1.

As described above in the exemplary embodiment of FIG. 7, when the reference block is two or more, the decoder may derive the error compensation values for the current block by the weighted sum of the error block values. In addition, according to the exemplary embodiment of the present invention, the weighting value may be set by using the derived motion information for the current block.

Referring S1310 of FIG. 13, the motion vector of reference picture list 0 and the motion vector of reference picture list 1 are symmetrical with each other. In this case, the decoder may not apply the error compensation values at the time of deriving the pixel values of the final prediction block. Therefore, when the motion vector of reference picture list 0 and the motion vector of reference picture list 1 are symmetrical with each other, the weighting value may be set to be 0.

Referring S1320 of FIG. 13, the motion vector of reference picture list 0 and the motion vector of reference picture list 1 are not symmetrical with each other. In this case, the decoder may apply the error compensation values at the time of deriving the pixel values of the final prediction block. For example, the weighting values used at the time of deriving the error compensation values may be each set to be ½.

As described above in the exemplary embodiment of FIG. 3, the decoder may derive the pixel values of the final prediction block for the current block by using the pixel values and the error compensation values of the prediction block. The detailed exemplary embodiment of the method for deriving the pixel values and the error compensation values of the prediction block are described above in the exemplary embodiment of FIGS. 4 to 13.

When the reference block is one, the decoder may derive the pixel values of the final prediction block by adding the error compensation values to the pixel values of the prediction block.

When the reference block is one, the decoder may use the pixel values and the error compensation values of the prediction block derived at the previous process upon deriving the final prediction block pixel values. In this case, the error compensation values for the pixels to be predicted in the current block may be the values to which the same error parameters as each other are applied.

In the case of the above description, the pixel values of the final prediction block for the 0-order error model may be represented by the following Equation 21 according to the exemplary embodiment of the present invention.

Pixel value of final prediction block(x,y)=pixel value of prediction block(x,y)+b [Equation 21]

Where (x, y) is a coordinate of the pixel to be predicted in the current block. b, which is the DC offset, corresponds to the error parameter of the 0-order error model.

In the case of the above description, the pixel values of the final prediction block for the 1-order error model may be represented by the following Equation 22 according to the exemplary embodiment of the present invention.

Pixel value of final prediction block(x,y)=a*pixel value of prediction block(x,y)+b [Equation 22]

Where a and b correspond to the error parameters of the 1-order error model.

When the reference block is one, the decoder may use both of the pixel values and the error compensation values of the prediction block derived at the previous process and the information on the position in the current block of the pixels to be predicted upon deriving the pixel values of the final prediction block.

In the case of the above description, the pixel values of the final prediction block for the 0-order error model may be represented by the following Equation 23 according to the exemplary embodiment of the present invention.

Pixel value of final prediction block(x,y)=pixel value of prediction block(x,y)+b*(x,y) [Equation 23]

Alternatively

Pixel value of final prediction block(x,y)=pixel value of prediction block(x,y)+b(x,y)

Where w (x, y) is the weighting value to which error parameter b is applied. Referring to Equation 23, weighting value w (x, y) and error parameter b (x, y) may have different values according to the position in the current block of the pixels to be predicted. Therefore, the pixel values of the final prediction block may be changed according to the position in the current block of the pixels to be predicted.

In the case of the above description, the pixel values of the final prediction block for the 1-order error model may be represented by the following Equation 24 according to the exemplary embodiment of the present invention.

Pixel value of final prediction block(x,y)=a*w1(x,y)*pixel value of prediction block(x,y)+b*w2(x,y) [Equation 24]

Alternatively

Pixel value of final prediction block(x,y)=a(x,y)*pixel value of prediction block(x,y)+b(x,y)

Where w1 (x, y) is the weighing value to which the error parameter a is applied and w2 (x, y) is the weighting value to which error parameter b is applied. Referring to Equation 24, weighting value w1 (x, y), weighting value w2 (x, y), error parameter a (x, y), and error parameter b (x, y) may have different values according to the position in the current block of the pixels to be predicted. Therefore, the pixel values of the final prediction block may be changed according to the position in the current block of the pixels to be predicted.

When a large coding unit (CU) is used, when the same error parameter is applied to all the pixels in the large coding unit, the coding/decoding efficiency may be reduced. In this case, the coder and the decoder may improve the coding/decoding performance by using both of the information on the position in the current block of the pixels to be predicted and the information different therefrom.

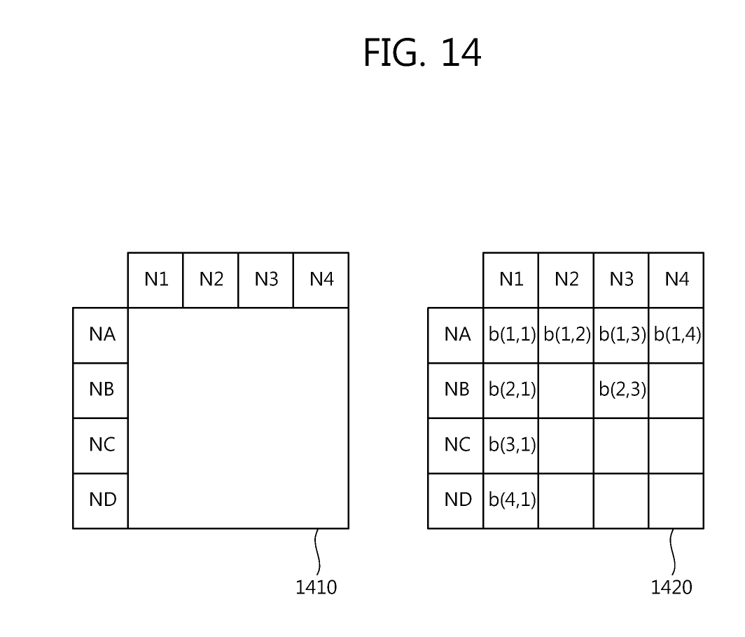

FIG. 14 is a conceptual diagram showing an exemplary embodiment of a method of deriving pixel values of a final prediction block using information on positions of a prediction object pixels in the current block. In the exemplary embodiment of FIG. 14, it is assumed that the 0-order error model is used and the method for deriving the final prediction block pixel values according to the second Equation in the exemplary embodiment of Equation 23 is used.

It is assumed that S1410 of FIG. 14 represents the reference block, S1420 of FIG. 14 represents the current block, and the size of the reference block and the current block is 4×4. In the exemplary embodiment of FIG. 14, N1, N2, N3, and N4 represent the peripheral pixel adjacent to the tops of the current block and the reference block and NA, NB, NC, and ND represent the peripheral pixel adjacent to the lefts of the current block and the reference block. The pixel values of the neighboring pixels of the reference block and the pixel values of the neighboring pixels of the current block may be different from each other.

Referring to FIG. 14, 16 error parameters b for 16 pixels within the current block may be derived. Each error parameter has different values according to the position of the pixels corresponding to the error parameters.

According to the exemplary embodiment, error parameters b (2, 3) may be derived by using only the information included in pixel N3 and pixel NB among the neighboring pixels of the current block and the neighboring pixels of the reference block.

According to the exemplary embodiment of the present invention, the decoder derives only some b (i, j) of the error parameters and then, the remaining error parameters may be derived by using the previously derived error parameter information and/or the information included in the peripheral pixels. For example, the remaining error parameters may be derived by the interpolation or the extrapolation of the previously derived error parameters.

For example, referring to FIG. 14, the decoder may first derive 3 parameters such as b(1,1), b(4,1), and b(1,4). In this case, the decoder may obtain b(1,2) and b(1,3) by the interpolation of b(1,1) and b(1,4) and b(2,1) and b(3,1) by the interpolation of b(1,1) and b(4,1). Similarly, the rest b (i, j) may also be obtained by the interpolation or the extrapolation of the error parameter value b nearest thereto.

When the reference block is two or more, the decoder may generate at least two prediction blocks by separately using each reference block and may derive the pixel values of the prediction block for the current block by using the weighted sum of the pixel values of at least two reference blocks. In this case, the decoder may derive the error block values for each prediction block and one error compensation value for the current block may also be derived by using the weighting value of the error block values.

When the decoder derives only one of each of the pixel values of the prediction block for the current block and the error compensation values for the current block by the weighting value, the pixel values of the final prediction block may be derived by the similar method to the case in which the reference block is one.

When the decoder derives the pixel values of at least two prediction blocks by separately using each reference block and derives only the error block values for each of the prediction block rather than one error compensation value, the decoder may use only the error block values having values of a specific size or more to derive the final prediction block pixel values or may also use only the error block values having values of a specific size or less to derive the final prediction block pixel value. According to the exemplary embodiment of the present invention, when the 0-order error model is used, the method may be represented by the following Equation 25.

Pixel value of final prediction block(x,y)=1/N(pixel value of prediction block 1(x,y)+error block value 1(x,y)*Wₜₕ)+1/N(pixel value of prediction block 2(x,y)+error block value 2(x,y)*Wₜₕ)+ . . . +1/N(pixel value of prediction block N(x,y)+error block value N(x,y)*Wₜₕ) [Equation 25]

Where wₜₕ is a value multiplied by the error block value so as to represent whether the error block value is used. In addition, the pixel values of the prediction block in the exemplary embodiment of Equation 25 are valued derived by separately using each of the reference block.

In the exemplary embodiment of Equation 25, for example, only the error block value having a value of the specific size or more may be used to derive the final prediction block pixel value. That is, for each of the prediction block value, when error parameter b is larger than a predetermined threshold, the Wₜₕ value may be 1, or the Wₜₕ value may be 0.

In the exemplary embodiment of Equation 25, for example, only the error block value having a value of the specific size or smaller may be used to derive the final prediction block pixel value. That is, for each of the prediction block value, when error parameter b is smaller than a predetermined threshold, the Wₜₕ value may be 1, or the Wₜₕ value may be 0.

When the decoder derives the pixel values of at least two prediction blocks by separately using each of the reference blocks and derives only the error block values for each of the prediction blocks rather than one error compensation value, the decoder may derive the pixel values by the weighted sum of the prediction blocks and the error block values. According to the exemplary embodiment of the present invention, the pixel value of the final prediction block derived by the method may be represented by the following Equation 26.

Pixel value of final prediction block(x,y)=W_{P1}*(pixel value of prediction block 1(x,y)+W_{E1}*error block value 1(x,y)+W_{P2}*pixel value of prediction block 2(x,y)+W_{E2}*error block value 2(x,y)+ . . . +W_{PN}*pixel value of prediction block N(x,y)+W_{EN}*error block value N(x,y) [Equation 26]

Where each of the W_{P} and W_{E} represents the weighting value. In this case, the weighting values may be set using the distance information between the current block and the prediction blocks corresponding to each reference block. In addition, when the reference block is at least two, at least two motion information indicating each reference block may be present and the weighting value may also be defined using the directivity information on each motion information. In addition, the weighting value may be set using the symmetric information between respective motion information.

The weighting value may be adaptively obtained by using at least one of the above-mentioned exemplary embodiments. In addition, the method for defining the weighting value is not limited to the above-mentioned exemplary embodiments and therefore, the weighting value may be defined by various methods according to the implementations.

The above-mentioned error compensation scheme used for the prediction in the skip mode is not applied at all times but may be selectively applied according to the coding scheme of the current picture and the block size.

According to the exemplary embodiment of the present invention, a slice header, a picture parameter set, and/or a sequence parameter set, including the information on which the error compensation is applied, may be transmitted to the decoder. For example, when the information is included in the slice header, the decoder may apply the error compensation for the slice when the information value is a first logical value and may not apply the error compensation to the slice when the information value is the second logical value.

In this case, when the information is included in the slice header, whether the error compensation is applied may be changed for each slice. When the information is included in the picture parameter set, whether the error compensation is applied may be controlled for all the slices using the corresponding picture parameters. When the information is included in the sequence parameter set, whether the error compensation is applied may be controlled for each slice type. An example of the slice type may include I slice, P slice, B slice, or the like.

The information may differently indicate whether the error compensation is applied according to the block size of the coding unit, the prediction unit, or the like. For example, the information may include the information that the error compensation is applied only in the coding unit (CU) and/or the prediction unit (PU) having the specific size. Even in the case, the information may be transmitted by being included in the slice header, the picture parameter set, and/or the sequence parameter set.

For example, it is assumed that the maximum CU size is 128×128, the minimum CU size is 8×8, the depth of the coding tree block (CTB) is 5, and the error compensation is applied only to the CU having 128×128 and 64×64 size. In this case, when the error compensation is applied for each CU size, since the size of the CU is 5 and the depth of the CTB is 5, five flag information is needed so as to indicate whether the error compensation is applied. According to the exemplary embodiment of the present invention, the flag information may be represented by 11000 and/or 00011 or the like.

When the depth of the CTB is large, it may be inefficient to transmit the information on whether the error compensation is applied for each CU size. In this case, a method for defining a table for predetermined several cases and transmitting an index indicating the information indicated on the table to the decoder may also be used. The defined table may be similarly stored in the coder and the decoder.

The method of selectively applying the error compensation is not limited to the exemplary embodiments and therefore, various methods may be used according to the implementations or need.

Even in the intra mode, when the prediction mode similar to the skip mode of the inter mode may be used, that is, when the prediction block is generated using the information provided from the peripheral blocks and the prediction mode to which the separate residual signal is not transmitted may be used, the exemplary embodiments of the present invention as described above may be applied.

In the case in which the prediction method of using the error compensation according to the exemplary embodiment of the present invention is used, in the case in which the inter-picture illumination change is serious, in the case in which the quantization of the large quantization step is applied, and/or in other general cases, the errors occurring in the skip mode may be reduced. Therefore, when the prediction mode is selected by the rate-distortion optimization method, a rate in which the skip mode is selected by the optimal prediction mode may be increased and therefore, the compression performance of the video coding may be improved.

The error compensation according to the exemplary embodiment of the present invention used for the skip mode may be performed by using only the information of the previously coded block, such that the decoder may perform the same error compensation as the coder without the additional information transmitted from the coder. Therefore, the coder needs not to transmit the separate additional information to the decoder for the error compensation and therefore, the information amount transmitted from the coder to the decoder may be minimized.

In the above-mentioned exemplary system, although the methods have described based on a flow chart as a series of steps or blocks, the present invention is not limited to a sequence of steps but any step may be generated in a different sequence or simultaneously from or with other steps as described above. Further, it may be appreciated by those skilled in the art that steps shown in a flow chart is non-exclusive and therefore, include other steps or deletes one or more steps of a flow chart without having an effect on the scope of the present invention.

The above-mentioned embodiments include examples of various aspects. Although all possible combinations showing various aspects are not described, it may be appreciated by those skilled in the art that other combinations may be made. Therefore, the present invention should be construed as including all other substitutions, alterations and modifications belong to the following claims.

1. A video decoding method, comprising:
deriving a pixel value of a prediction block for a current block;
deriving an error compensation value for the current block; and
deriving a pixel value of a final prediction block by using the pixel value of the prediction block and the error compensation value,
wherein the error compensation value is a sample value of the error compensation block for compensating an error between the current block and the reference block and the reference block, which is a block in a reference picture, is a block including prediction value (predictor) related information of the pixel in the current block, and
the prediction for the current block is performed in an inter-picture skip mode.

2. The video decoding method of claim 1, wherein the deriving of the pixel value of the prediction block for the current block includes:
deriving motion information on the current block by using a previously decoded block; and
deriving the pixel value of the prediction block by using the derived motion information.

3. The video decoding method of claim 2, wherein the previously decoded block includes neighboring blocks of the current block.

4. The video decoding method of claim 2, wherein the previously decoded block includes the neighboring blocks of the current block and neighboring blocks of a collocated block in the reference picture.

5. The video decoding method of claim 2, wherein at the deriving of the pixel value of the prediction block by using the derived motion information, the pixel value of the derived prediction block is a pixel value of the reference block indicated by the derived motion information.

6. The video decoding method of claim 2, wherein when the reference block is two or more, at the deriving of the pixel value of the prediction block by using the derived motion information, the pixel value of the prediction block is derived by a weighted sum of the pixel values of the reference block and the reference block is a block indicated by the derived motion information.

7. The video decoding method of claim 1, wherein the deriving of the error compensation value for the current block includes:
deriving the error parameter for an error model of the current block; and
deriving an error compensation value for the current block by using the error model and the derived error parameter.

8. The video decoding method of claim 7, wherein the error model is a 0-order error model or a 1-order error model.

9. The video decoding method of claim 7, wherein at the deriving of the error parameter for the error model of the current block, the error parameter is derived by using the information included in the neighboring blocks of the current block and the block in the reference picture.

10. The video decoding method of claim 7, wherein when the reference block is two or more, at the deriving of the error compensation value for the current block by using the error model and the derived error parameter, the error compensation value is derived by a weighted sum of the error block values and the error block value is the derived error compensation value of the current block for each of the reference blocks.

11. The video decoding method of claim 1, wherein at the deriving of the pixel value of the final prediction block by using the pixel value of the prediction block and the error compensation value,
the error compensation value is selectively used according to information indicating whether error compensation is applied and the information indicating whether the error compensation is applied is transmitted from a coder to a decoder by being included in a slice header, a picture parameter set, or a sequence parameter set.

12. A prediction method of an inter-picture skip mode, comprising:
deriving a pixel value of a prediction block for a current block;
deriving an error compensation value for the current block; and
deriving a pixel value of a final prediction block by using the pixel value of the prediction block and the error compensation value,
wherein the error compensation value is a sample value of the error compensation block for compensating an error between the current block and the reference block and the reference block, which is a block in a reference picture, is a block including prediction value related information of the pixel in the current block.

13. The prediction method of claim 12, wherein the deriving of the pixel value of the prediction block for the current block includes:
deriving motion information on the current block by using a previously decoded block; and
deriving the pixel value of the prediction block by using the derived motion information.

14. The prediction method of claim 12, wherein the deriving of the error compensation value for the current block includes:
deriving the error parameter for an error model of the current block; and
deriving an error compensation value for the current block by using the error model and the derived error parameter.

15. A video decoding apparatus, comprising:
an entropy decoder performing entropy decoding on bit streams received from the decoder according to probability distribution to generate residual block related information;
a predictor deriving a pixel value of a prediction block for a current block and an error compensation value for the current block and deriving a pixel value of a final prediction block by using the pixel value of the prediction block and the error compensation value; and
an adder generating a recovery block using the residual block and the final prediction block,
wherein the error compensation value is a sample value of the error compensation block for compensating an error between the current block and the reference block and the reference block, which is a block in a reference picture, is a block including prediction value related information of the pixel in the current block, and
the predictor performs the prediction for the current block in an inter-picture skip mode.

16. The video decoding apparatus of claim 15, wherein the predictor derives motion information on the current block by using a previously decoded block and derives the pixel value of the prediction block by using the derived motion information.

17. The video decoding apparatus of claim 15, wherein the predictor derives the error parameter for an error model of the current block and derives an error compensation value for the current block by using the error model and the derived error parameter.
